(19) United States
(12) Patent Application Publication
(10) Pub. No.: US 2015/0086962 A1
(43) Pub. Date: Mar. 26, 2015

(54) Methods and Systems for Testing and Correcting

(71) Applicant: UNIVERSITEIT ANTWERPEN, Antwerpen (BE)

(72) Inventors: Raoul Rein Maria Arnold Deuss, Kessel-Lo (BE); Christine Eleonora Lippens, Hombeek (BE)

(21) Appl. No.: 14/396,427

(22) PCT Filed: Apr. 23, 2013
(86) PCT No.: PCT/EP2013/058398

§ 371 Date: Oct. 23, 2014

Related U.S. Application Data
(60) Provisional application No. 61/636,766, filed on Apr. 23, 2012.

(51) Int. Cl. G09B 7/00

(52) U.S. Cl. CPC G09B 7/00
USPC 434/353; 434/322

(57) ABSTRACT

A computer-implemented method comprises receiving a data-input representative for a question/answer combination having an inherent question type, and, for processing the data input representative for a question/answer combination. The method includes identifying for the data-input, a set of data building blocks representative for the question/answer combination. The data building blocks are hierarchically structured according to a predetermined data structure irrespective of the inherent question type of the question/answer combination.

### FIELD OF THE INVENTION

The invention relates to the field of electronic learning environments. More particularly, the present invention provides methods and systems for providing test tools and correction tools for use in an electronic learning environment.

### BACKGROUND OF THE INVENTION

Existing test (or examination) and correction applications based on question types are used to provide and correct exercises, assignments and exams electronically, and to give participants (students) feedback. The objective of these correction applications is to provide the user (teacher) an instrument to accomplish these tasks in a more efficient and faster way. The increased efficiency allows the user to offer exercises, assignments and tests to participants of his course on a regular basis, so that he can gain better visibility and control of their learning process, and so that he can influence it, if desired.

Although users support this vision, experience shows that participants make little or no use of such improvement applications. The low use of such applications has a negative impact on the return on investment and is a contributory cause of major controversy between supporters and opponents of such applications. The controversy is thereby severely contaminated by arguments which hide the structural causes of the problem. The cause of the controversy between advocates and opponents (non-users and users) can however be easily described, if one focuses on the capabilities of the used test and correction application (question types). If one takes a test and correction application (question types) then one may list its capabilities as follows:
(1) The question of a user can seamlessly be translated (transformed) into the correction application
(2) The question of a user can be translated into the correction application to a question that contains more information than the original phrasing of the user
(3) The question of a user can be translated as in (1) & (2), but falls apart in multiple questions
(4) The question of a user can be translated as in (1) & (2) & (3), but the correction method is not as desired
(5) The question of a user cannot be translated into the correction application.

It goes without saying that point (1) (seamless translation/transform) is used by the supporters, but it should be noted that the number of question types is limited, and consequently also the scope of the application to seamlessly convert questions. The latter is therefore seized upon by opponents. Point (5), i.e. the question of the user cannot be translated into the correction application, is at present the main reason why teachers do not use the application.

Point (2), i.e. the fact that in order to pose the full question, the student is to be provided with more information than would be the case with conventional questioning, is the main reason why proponents tend to match their problem phrasing more and more to the capabilities of the application. Opponents will use exactly this aspect, and the reaction that it brings about with the proponents, as an opportunity to principally reject the use of such applications.

Point 3, i.e. the need for separating the question into multiple questions and Point 4 being the correction method not being optimum, refer to structural problems in this kind of applications, but which are technically solvable if the manufacturers would wish. Point 3 should be also be regarded as a presentation problem.

The basic actions performed in the system are the introduction of questions in the system and the correction process. The way of creating a question in known correction applications based on question types, is as follows. The editor (user interface) of this correction application consists of a list of question types from which the teacher can select. Upon selection a template of this type of question is presented, where the teacher can enter the data and may edit it to some extent. Specifically,
1) The user (teacher) formulates his question
2) The user evaluates the types of questions which are provided in the application
3) The user translates (or transforms) his question into a question type (or set of question types) available in the application improvement
4) The user enters the result of the translation with the editor, and
5) The application saves the input. Thus the user chooses from question types to electronically formulate his questions. The user has to classify his questions into the predefined question types.

The way for correction an answer in known correction applications based on question types, is as follows. A test is a set of questions, each question being formulated according to a question type, the student answers the questions by selecting or providing one or more answers. Assuming that each ‘question type’ involves a proper correction algorithm, it can be stated that the correction algorithm of a test (or exam) proceeds as follows.
1) The application retrieves the correction key (i.e. the list of correct answers) corresponding to the selected test,
2) The application retrieves a submitted key (i.e. the list of the participant's answers),
3) For each answer in the correction key, the application takes the corresponding answer from the submitted key. The application thus delivers the corresponding answers to the correction algorithm of the specific ‘question type’, which offers a corrected submitted answer for the question.
4) The application calculates the total score on the basis of the corrected submitted answers.

One may therefore say that:
1) The scope of the correction application can be enhanced by introducing a new ‘question type’ and by implementing an additional correction algorithm,
2) The theoretical scope of the correction application is determined by the algorithmic possibility to correct a ‘question type’,
3) The actual scope of the correction application is determined by the number and kind of the ‘question types’.

It should be mentioned that the notion of “question type” is not uniform amongst different producers, and some interpret the term in a rather broad manner.

There still is a need for good test and correction applications in electronic learning environments.

### SUMMARY OF THE INVENTION

It is an object of embodiments of the present invention to provide good methods and systems for generating test materials and correction tools in an electronic learning environment that provide large flexibility.

It is an advantage of embodiments of the present invention that a method and system is provided that allows the teacher to formulate his question in the format he wishes to formulate the question and to correct his question in the format he wishes to correct the question, without the need for adjusting the implementation, e.g. computer code, of the learning environment.

It is an advantage of embodiments according to the present invention to provide methods and systems that allow the teacher to provide for their students questions in an electronic learning environment that correspond closely with the content, the shape and the way of correction of the original question phrased by the teacher.

It is an advantage of embodiments according to the present invention that the teacher can provide for their students questions in an electronic learning environment, without the need for making more information available than would be the case if the question was posed without electronic learning environment. The latter furthermore does, according to embodiments of the present invention, not limit the possibility to have a full electronic correction tool for the question.

It is an advantage of embodiments according to the present invention that the question type that the teacher wants to use can be implemented in the electronic learning environment, irrespective of the question type, for example, i.e. not necessary to convert certain question types into other or several questions recognized programmed for the electronic learning environment in order to allow for full electronic correction.

It is an advantage that types of questions that in existing prior art learning environments cannot be translated to a question or set of questions without expanding the application by programming, can be presented to a user and can be corrected in a system according to an embodiment of the present invention.

It is an advantage that there are types of questions, which in existing prior art learning environments need to be translated into a question or set of questions wherein the teacher is obliged to provide more information (e.g. regarding the possible answer) than initially intended (e.g. than required when oral examination is performed), which in a system according to an embodiment of the present invention can be presented identical or structurally identical to the question as would be presented as intended.

It is an advantage that each type of question that can be presented in existing prior art by one or more questions, can be presented in a system according to an embodiment of the present invention as a single question.

It is an advantage of embodiments according to the present invention that methods and systems can be provided that allow for full electronic correction of questions. Furthermore, electronic correction can be tuned as required by the teacher, thus providing a large flexibility in correction of questions. The latter is obtained as the teacher can indicate for each part of the question posed how it should be quoted and corrected. Furthermore, the teacher can define rules for correcting the question as a whole, thus allowing more accurate correction than merely checking if different parts are correct. In other words, consistency between the parts can be taken into account.

The above objective is accomplished by a method and device according to the present invention. In a first aspect, the present invention may relate to a computer-implemented method for testing in an electronic learning environment, the computer-implemented method comprising

receiving a data-input representative for a question/answer combination, the question/answer combination having an inherent question type, and,

for processing the data input representative for a question/answer combination, identifying for the data-input, a set of data building blocks representative for the question/answer combination, the data building blocks being hierarchically structured according to a predetermined data structure irrespective of the inherent question type of the question/answer combination.

The method furthermore may comprise sorting the hierarchically structured data building blocks for processing them, wherein the sorting is performed according to a predetermined sorting algorithm, the predetermined sorting algorithm being irrespective or independent of the inherent question type of the question/answer combination.

The method may be adapted for using at least a type of higher level building blocks and a type of lower level building blocks whereby a plurality of lower level building blocks can be linked to one higher level building block, and the sorting may comprise first sorting higher level building blocks and then sorting lower level building blocks. It is an advantage of embodiments according to the present invention that accurate correction can be obtained independent of the type of question, by using a sorting algorithm in a particular data structure.

At least two types of hierarchically structured building blocks may be present.

Four types of hierarchically structured building blocks may be present,

a first type of building block (element) which represents a smallest structural content unit of a question/answer combination,

a second type of building block (thread) which is a sequence of consecutive first type of building blocks and/or third types of building blocks,

a third type of building block (rack) which is a collection of second type of building blocks and constitutes the question, and

a fourth type of building block (cluster) being a collection of similar first, second and/or third type of building blocks.

It is an advantage that a full description for a testing application in a learning environment can be obtained based on four types of building blocks.

Sorting may comprise

starting from the third type of building block constituting the question,

first sorting threads through thread clusters, and

then sorting elements or racks through their clusters.

The method also may comprise scoring a question/answer combination obtained from a student by comparing the building blocks with building blocks of an expert question/answer combination.

Receiving a data-input representative for a question/answer combination may comprise receiving a data-input representative for a nested question/answer combination, the nested question/answer combination combining a plurality of different inherent question types.

It is an advantage of embodiments according to the present invention that complex questions can be accurately be presented and corrected, without the need for re-programming the learning environment, by using nested structures.

The method furthermore may comprise receiving an adapted expert question/answer combination based on received question/answer combinations from students as reply to an original question/answer combination.

A higher type building block may comprise boundary conditions or allowed deviations for the question/answer combination of the student, with respect to an expert question/answer combination.

The present invention also relates to a system for testing in an electronic learning environment, the system comprising an input means for receiving a data-input representative for a question/answer combination, the question/answer combination having an inherent question type, and a processor programmed for identifying for the data-input, a set of data building blocks representative for the question/answer combination, the data building blocks being hierarchically structured according to a predetermined data structure irrespective of the inherent question type of the question/answer combination.

The system may furthermore be adapted for performing a method for testing as described above.

The system may be implemented as a computer application comprising a teacher application component and a student application component.

The present invention also relates to a computer program product for, if implemented on a processing unit, performing a method as described above.

The present invention furthermore relates to a data carrier storing a computer program product as described above or to the transmission of a computer program product over a wide or local area network.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 illustrates an exemplary method for testing in an electronic learning environment according to an embodiment of the present invention.

FIG. 2 illustrates a schematic overview of a system for testing in an electronic learning environment, according to an embodiment of the present invention.

FIG. 3 illustrates a unified modeling language scheme of an example of a question/answer combination expressed as building blocks in a data structure, as can be used in embodiments of the present invention.

FIG. 4 illustrates a unified modeling language scheme of an example of a cluster, as can be used in embodiments of the present invention.

FIG. 5 illustrates a unified modeling language scheme of a question of a student.

FIG. 6 illustrates an XML scheme for an element, as can be used in embodiments according to the present invention.

FIG. 7 illustrates a unified modeling language scheme for a thread, as can be used in embodiments according to the present invention.

FIG. 8 illustrates an example of a rack introduced as element in a thread, as can be obtained using an embodiment according to the present invention.

FIG. 9 illustrates an exemplary scheme of a sorting process that can be applied in an embodiment of the present invention.

FIG. 10 shows how a first example question is presented on paper in world 1.

FIG. 11 shows how the first example question is presented in world 2, using “Multiple Blanks” in a question type based application.

FIG. 12 shows a first part of how the first example question is presented in world 2, using “Multiple Response Options” in a question type based application.

FIG. 13 shows a second part of how the first example question is presented in world 2, using “Multiple Blanks” in a question type based application.

FIG. 14 shows how the first example question is implemented in the Aleph-Q model, according to an embodiment of the present invention.

FIG. 15 shows how a second example question is implemented in the Aleph-Q model, according to an embodiment of the present invention.

FIG. 16 shows an example of a correct response to the question of FIG. 15.

FIG. 17 shows how part of the third example question is presented in world 2, using “calculated numerical values”in a question type based application.

TABLE 1 shows corresponding data of how a third example question is presented on paper in world 1.

TABLE 2 shows the given data that is supplied along with the third example question.

FIG. 18 shows how part of the third example question is presented in world 2, using “Multiple Choice” in a question type based application.

FIG. 19 shows how the third example question is implemented in the Aleph-Q model, according to an embodiment of the present invention.

FIG. 20 shows an example of a correct response to a fourth example question, in world 1.

FIG. 21 shows how a part (debit side) of the fourth example question is presented in world 2 in a question type based application.

FIG. 22 shows how a part (credit side) of the fourth example question is presented in world 2 in a question type based application.

FIG. 23 shows how the fourth example question is implemented in the Aleph-Q model, according to an embodiment of the present invention.

The drawings are only schematic and are non-limiting. In the drawings, the size of some of the elements may be exaggerated and not drawn on scale for illustrative purposes.

Any reference signs in the claims shall not be construed as limiting the scope.

In the different drawings, the same reference signs refer to the same or analogous elements.

### DETAILED DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Where in embodiments according to the present invention, reference is made to an inherent question type, reference is made to a manner of questioning that cannot be categorized under, or is not equivalent to another manner of questioning. Examples of different question types are multiple response option questions, multiple blanks, numeric value, essay, . . . . On the other hand, for example, the different kind of questions ‘True/False’ (TF), ‘Likert scale’ (LS), ‘Multiple Choice’ (MC) and ‘Multiple Response Options’ (MRO) are not considered to be different question types, because the first two kinds mentioned (TF,LS) are derived from the ‘Multiple Choice’ (MC) kind, and this in turn is a derivative of the ‘Multiple Response Options’ (MRO) kind So one can say that a ‘Multiple Choice’ question is a special kind of ‘Multiple Response Options’ question whereby only one option is a correct answer to the question. In short, the difference between the ‘question kinds’ mentioned in this paragraph is merely the manner of presentation, and therefore has no effect on the correction algorithm. Mathematically formulated, one can say that the collection of True/False-questions, Likert-questions and Multiple Choise-questions form a subcollection of the Multiple Response Option-questions, {q_TF, q_likert, q_MC} ⊂ q_MRO.

According to embodiments of the present invention, the question/answer combination can be presented and/or corrected using a process that is independent of an inherent question type of the question/answer combination. The inherent question type of a question/answer combination expresses the response structure by which the student is expected (by the teacher) to reply to a question, such as for example by selecting one of a set of possible answers, by providing a numerical value, by providing one or more textual answers, etc. In other words, the method of processing for correcting is independent of the response structure by which the student is expected to reply to a question.

Where in embodiments according to the present invention, reference is made to a “question/answer combination”, reference is made to an identification of a question posed, and the corresponding answer provided to the question. The identification of the question posed may be the question itself or any other identifier identifying the question, such as for example a question number. The answer may consist of more than one value. The “question/answer combination” may be an “expert question/answer combination” indicative of the question and the expected answer provided by a teacher, or it may be a “student question/answer combination” being indicative of the question and the corresponding answer as given by the student, e.g. during a test.

Where in embodiments according to the present invention reference is made to a “teacher”, reference is made to the person wishing to present the question as a test. Where in embodiments according to the present invention reference is made to a “student”, reference is made to the person that has to answer the question, e.g. as a test. Consequently, although the terminology “teacher” and “student” is used, this does not automatically imply a school or university setting, but may also be applicable to other fields where testing in an electronic learning environment can be used.

Where in embodiments according to the present invention reference is made to “correction” or “correcting”, reference is made to scoring of an answer, i.e. providing a mark for an answer. Additionally “correction” or “correcting” may also include providing the expert answer to the student, although embodiments are not limited thereby.

In the present invention the terms “application” or “tool” are used as synonyms. Furthermore, such an application or tool also may be referred to as “test application”, “test and correction application”, “correction application”, “test tool”, “test and correction tool” and “correction tool”, as these provide the possibility to the teacher for phrasing questions as a test and for correcting received answers to the questions.

In a first aspect, the present invention relates to a computer-implemented method and system for testing in an electronic learning environment. According to embodiments of the present invention, the computer-implemented method comprises

receiving a data-input representative for a question/answer combination, the question/answer combination having an inherent question type, and,

for processing the data input representative for a question/answer combination, identifying for the data-input, a set of data building blocks representative for the question/answer combination, the data building blocks being hierarchically structured according to a predetermined data structure, irrespective of the inherent question type of the question/answer combination.

According to particular embodiments of the present invention, the method and system furthermore may comprise or be adapted for sorting the hierarchically structured data building blocks for processing them, wherein the sorting is performed according to a predetermined sorting algorithm, the predetermined sorting algorithm being irrespective or independent of the inherent question type of the question/answer combination.

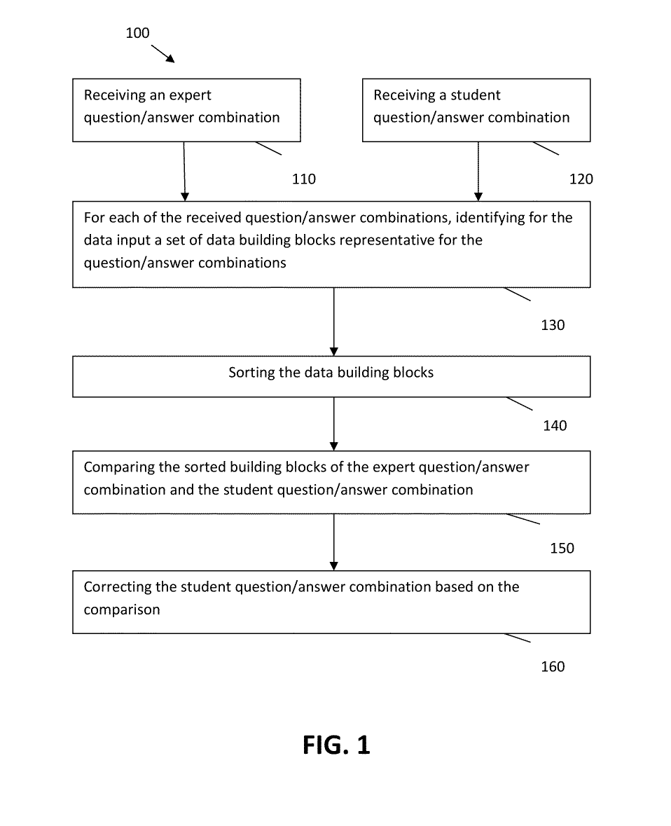

It is an advantage of embodiments according to the present invention that the method and system for testing does not make use of the specific question type of a question for presenting or correcting the question/answer combination. Rather use is made of a data structure, which could also be referred to as data model, with hierarchical building blocks resulting in the possibility for processing question/answer combinations, irrespective or independent of their inherent question type. The method and system according to embodiments of the present invention is a computer implemented method and system. The teacher typically may introduce or build the question/answer combination in an application or computer-implemented tool, whereafter the application or tool identifies building blocks representative for the question/answer combination. Such identifying may comprise converting the question/answer combination into a set of building blocks. The application typically may further process the question/answer combination, e.g. by sorting the building blocks. Also further steps may be provided. In some embodiments, the computer-implemented method may for example comprise the standard and optional steps of an exemplary method as shown in FIG. 1.

The method 100 may comprise receiving 110 an expert question/answer combination, e.g. through an editor or interface provided for the teacher. The teacher thus forms a question—also referred to as building the question—electronically, by providing data input. Providing data input thereby typically may comprise providing the components building up the question and the expert answer by defining their values and identifying and/or changing their interrelations where required. The latter may for example be performed after the teacher has formulated the question. The method may be adapted for receiving the data input making use of a teacher-application. The question/answer combination may comprise the components making up the questions, components making up the expert answer, boundary conditions, allowed deviations, etc. A question/answer combination thus may be a dataset comprising informational data interconnected in a certain manner and having certain relations with respect to each other.

The components making up the expert answer, boundary conditions and allowed deviations may be fixed or it may be open to change, e.g. dependent on the student answers that will be provided (e.g. an unexpected answer that may earn some points but was not foreseen by the teacher). These components also may be referred to as the correction key. The information obtained or the information converted into building blocks, as identified in step 130 below, typically may be stored and part thereof may be used for phrasing a question to the student during a test.

The method 100 may also comprise receiving 120 student question/answer combinations, e.g. through an interface provided for the student. The student therefore typically is provided with the question presented based on the input data or the identified building blocks for the question as provided by the teacher.

For each of the received question/answer combinations, the application then may identify 130 for the data-input, a set of data building blocks representative for the question/answer combination, the data building blocks being hierarchically structured according to a predetermined data structure irrespective of the inherent question type of the question/answer combination.

In yet a further step, the data building blocks may be sorted 140. The sorting may be sorting the hierarchically structured data building blocks for processing them, wherein the sorting is performed according to a predetermined sorting algorithm, the predetermined sorting algorithm being irrespective or independent of the inherent question type of the question/answer combination. Sorting the building blocks of the answer that is provided by the student thereby may be based on the sorted building blocks of the expert answer, their interconnections and interrelations. For this ordening, ordening principles are used making use of boundary conditions determined by the teacher. During this ordening, the status of certain building blocks of the answer provided by the student may be changed.

In still a further step, the sorted building blocks for the expert question/answer combination and for the student question/answer combination are compared 150. In some embodiments, as indicated above, the student input may be used for adapting the components building up the answer as well as the boundary conditions and the allowed deviations, and thus a kind of feedback loop is established, if the teacher allows so. For this comparison, the lowest ordered building blocks of the correction key may be divided in collections. These collections can then be compared with the lowest ordered building blocks of the answer provided by the student, using predetermined principles making use of the boundary conditions determined by the teacher.

Based on the comparison 150, correction 160—i.e. a scoring—of the student question/answer combination is performed. If a test with a plurality of questions is presented to the student, a total score also may be determined, based on the obtained correction.

Further optional steps, known by the person skilled in the art, also may be implemented without departing from the present invention.

The above exemplary embodiment illustrates that the possibilities of the correction method and system can e.g. be extended by extending or refining the type and behavior of the building blocks, by extending or refining the relations between the building blocks, and/or by introducing new building blocks, e.g. in as far as these do not imply a new model. It will be clear that theoretically the scope of the correction application is primarily determined by the possibility to translate a question into the data model.

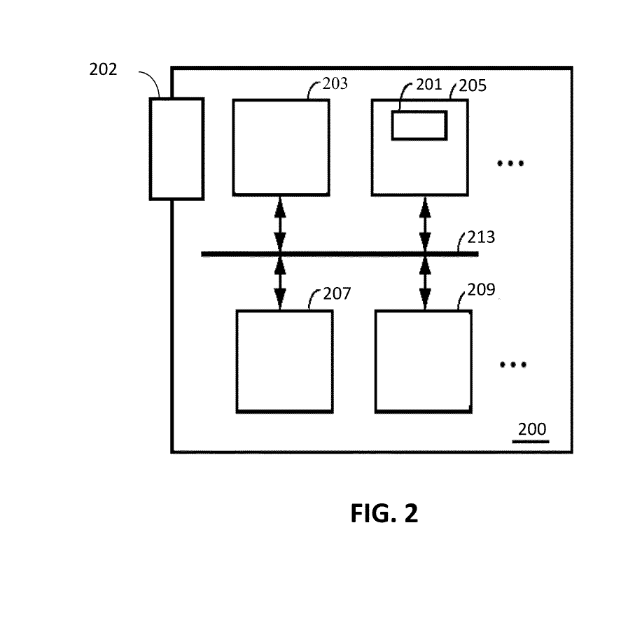

Comparison of the process for receiving input from the teacher (i.e. corresponding with a method for presenting a question) and of the process for correcting a question as described above with corresponding procedures used in conventional prior art learning environments, as described in the background section, allows to see the differences in the process.

Whereas up to now, embodiments of the present invention are mainly described with reference to method steps, it will be clear to the person skilled in the art that the present invention also relates to a system for testing. Such a system for testing typically will comprise an input means for receiving a data-input representative for a question/answer combination, the question/answer combination having an inherent question type, and a processor programmed or adapted for—in order to allow accurate processing of the data input representative for a question/answer combination—identifying for the data-input, a set of data building blocks representative for the question/answer combination, the data building blocks being hierarchically structured according to a predetermined data structure irrespective of the inherent question type of the question/answer combination. Further particular input means, processing means and/or output means adapted for performing the functionality as expressed in methods according to embodiments of the present invention also may be enclosed. The system may be a processing system 200 such as shown in FIG. 2. FIG. 2 shows one configuration of processing system 200 that includes at least one programmable processor 203 coupled to a memory subsystem 205 that includes at least one form of memory, e.g., RAM, ROM, and so forth. It is to be noted that the processor 203 or processors may be a general purpose programmed for performing the method steps, or a special purpose processor. Thus, one or more aspects of the present invention can be implemented in digital electronic circuitry, or in computer hardware, firmware, software, or in combinations of them. The processing system may include a storage subsystem 207 that has at least one disk drive and/or CD-ROM drive and/or DVD drive. An input means 202 is provided for receiving a data-input representative for a question/answer combination, the question/answer combination having an inherent question type.

In some implementations, a display system, a keyboard, and a pointing device may be included as part of a user interface subsystem 209 to provide for a user to manually input information. Ports for inputting and outputting data also may be included. More elements such as network connections, interfaces to various devices, and so forth, may be included, but are not illustrated in FIG. 2. The various elements of the processing system 200 may be coupled in various ways, including via a bus subsystem 213 shown in FIG. 2 for simplicity as a single bus, but will be understood to those in the art to include a system of at least one bus. The memory of the memory subsystem 205 may at some time hold part or all (in either case shown as 211) of a set of instructions that when executed on the processing system 200 implement the steps of the method embodiments described herein. Thus, while a processing system 200 such as shown in FIG. 2 is prior art, a system that includes the instructions to implement aspects of the methods is not known from prior art, and therefore FIG. 2 is not labelled as prior art.

The processing system 200 may be implemented as an application or tool. Typically such an application or tool typically may have an expert-application component, adapted or programmed for allowing receiving input from the teacher, such as for example an expert question/answer combination, and for providing output to the teacher, such as for example information regarding the corrected student question/answer combinations. The application or tool also may comprise a student-application component, adapted or programmed for allowing receiving input from the student and for providing output to the student, such as presenting the question to be answered and receiving question/answer combinations from the student.

The present invention also includes a computer program product which provides the functionality of any of the methods according to the present invention when executed on a computing device. Such computer program product can be tangibly embodied in a carrier medium carrying machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including but not limited to, non-volatile media, and transmission media. Non volatile media includes, for example, optical or magnetic disks, such as a storage device which is part of mass storage. Common forms of computer readable media include, a CD-ROM, a DVD, a flexible disk or floppy disk, a memory key, a tape, a memory chip or cartridge or any other medium from which a computer can read. Various forms of computer readable media may be involved in carrying one or more sequences of one or more instructions to a processor for execution. The computer program product can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fibre optics, including the wires that comprise a bus within a computer.

By way of illustration, further features and advantages of embodiments of the present invention will be described in more detail below, such features being standard or optional, embodiments of the present invention not being limited thereto.

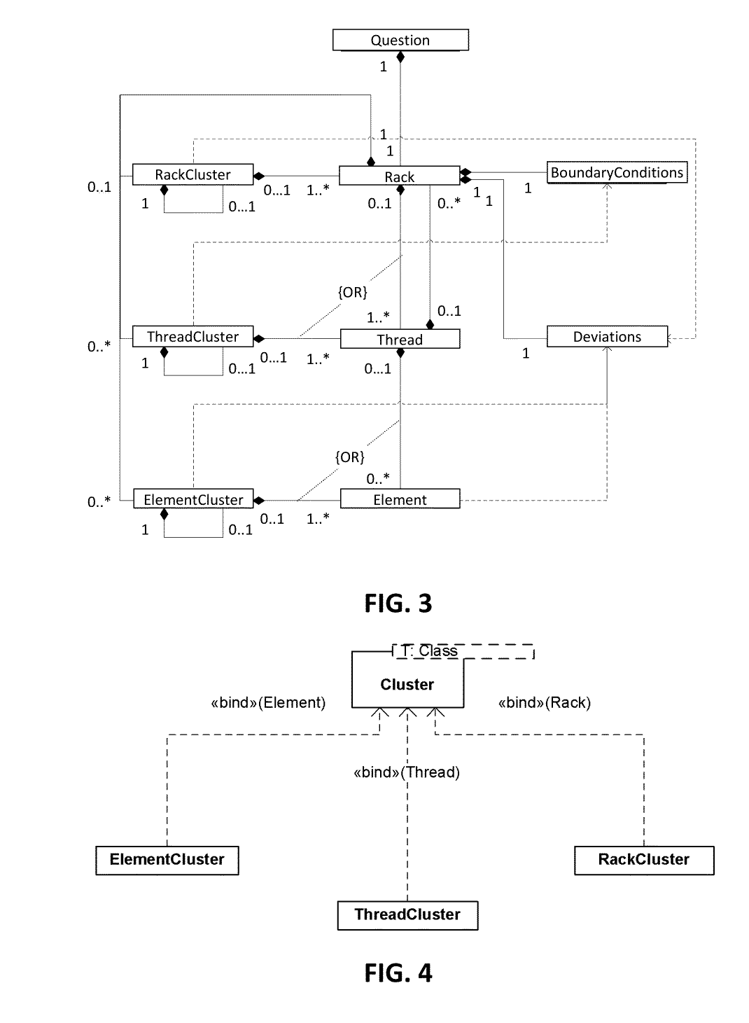

By way of illustration, some of the basic principles and concepts used, are illustrated below. In FIG. 3 a unified modeling language scheme of a question expressed as building blocks of a data structure is shown, illustrating principles and components of embodiments according to the present invention.

In FIG. 4, a unified modeling language scheme of a cluster is shown. Rack cluster, thread clusters and element clusters are particular implementations of the generic class of a cluster.

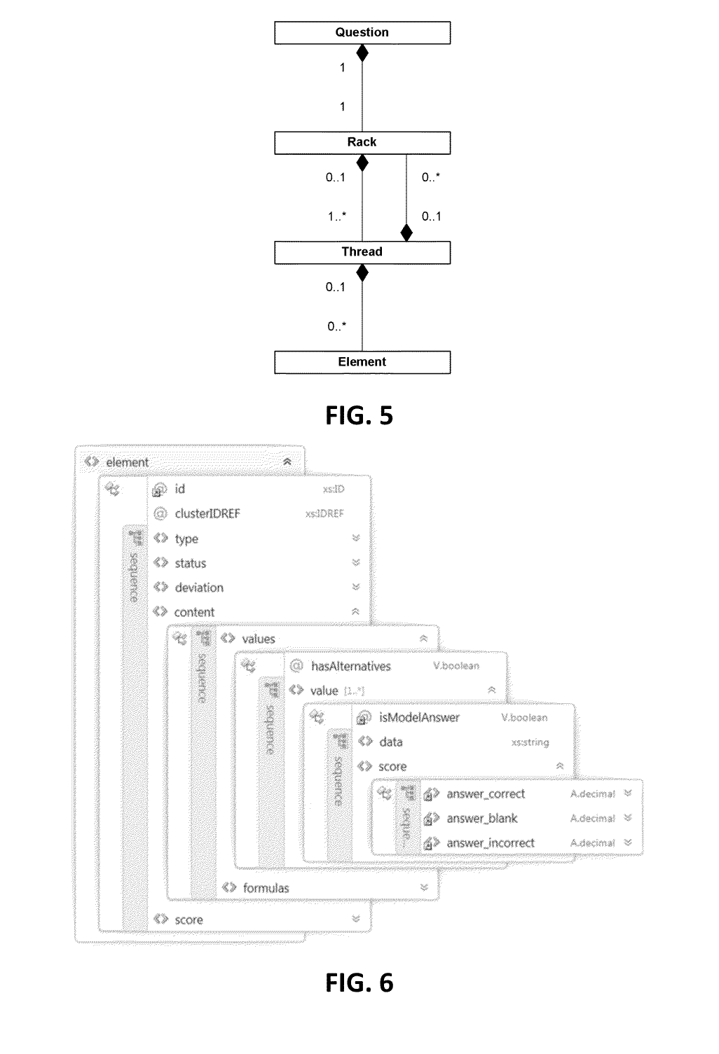

In FIG. 5, a unified modeling language scheme of a question of a student is shown.

One feature of a set of embodiments is the possibility of methods and systems according to embodiments of the present invention to deal with complex questions, such as nested questions or questions combining different question types. The latter can be obtained in embodiments of the present invention due to the use of the data structure, allowing to identify or convert the complex question into a set of building blocks which can be treated in a standard manner. The system therefore is not considered to be a question-type based system, wherein the possibility to handle a question from the teacher depends on whether or not a particular correction algorithm is written for the specific question posed.

Another feature of a set of embodiments according to the present invention, is the possibility provided for the teacher to take into account the question/answer combinations provided by students when correcting. The system or method therefore may be adapted for providing an overview of the different unique responses that are provided by the students, for providing an overview of the number of times certain responses have occurred, optionally completed with a statistical analysis, . . . . Based thereon, the teacher can decide to maintain the correction key, or to adapt the correction key, e.g. by providing partial marks for a non-complete but reasonable answer.

One feature of a particular set of embodiments of the present invention is the use of hierarchical building blocks. In some embodiments, the data structure used comprises at least two types of hierarchical ordered building blocks. In one example, a first building block being an elementary component comprising values is used, and a second building block, grouping a number of first building blocks is used. In another example three different, hierarchically ordered types of building blocks can be used. In still another set of embodiments, four different types of building blocks are used.

By way of illustration, embodiments of the present invention not being limited thereby, this example will be illustrated in more detail, whereby the four types of building blocks are referred to as elements, threads, racks and clusters. A question can, according to this set of embodiments, thus be defined as a set of elements, threads, racks and clusters and their interrelations. Standard and optional features of such different types of building blocks, will now be discussed in more details illustrated for the four building block system, embodiments of the present invention not being limited thereto.

According to the particular set of embodiments, an element can be the smallest building block that can be used for representing a question. The element thus can be the smallest structural content unit in a question. The element thereby can be a data sequence within the question that has a specific meaning or fulfills a specific role within the question. The question can thus be subdivided in a group of elements. For identifying elements, e.g. in a process of splitting a question in its different building blocks, optionally use can be made of one or more of the following principles:

A datasequence can be identified as an element if the datasequence, or the absence thereof, is to be corrected and marked.

A datasequence can be identified as an element if certain limitations need to be applied to the content of the datasequency, i.e. if a specific datatype is to be allocated thereto. Most of the datasequences can e.g. be considered as datatype string, although embodiments are not limited thereto and e.g. audiovisual data also are a datatype that could be used.

A data sequence can be considered an element if the application needs to consider and treat the data sequence as a certain data type.

Examples of different data types that could be used can be:

“StringSealed”: A data type for the data sequence indicating that the original data sequence is not altered.

“StringCleaned”: A data type for the data sequence indicating that the original data sequence is altered—unless it is a null value. The changes are only made in whitespace. Changes that e.g. can be implied are replacement of tabulator commands in the data sequence by spaces and thereafter, replacements of multiple consecutive spaces, linefeeds and carriage returns commands by single occurrences. In other words command #x9 (tab) is being replaced by the command #x20 (space) after which all subsequent consecutive occurrences of command #x20 (space), command #xA (linefeed) and command #xD (carriage return) are replaced by respective simple occurrences. Furthermore, whitespace before and after the data sequence is being deleted.

“Token”: A data type for the data sequence indicating that the original data sequence is altered—unless it is a null value—as follows: tabulator commands, linefeed commands and carriage return commands are replaced by space commands. In other words commands #x9 (tab), #xA (linefeed) and #xD (carriage return) are replaced by command #x20 (space). Furthermore, whitespace commands before and after the data sequence are deleted and consecutive occurrences of whitespace are being replaced by a single whitespace.

“Double”: A data type for the data sequency indicating that the original data sequence is converted—unless it is a null value—to a number.

A data sequence can furthermore be identified as an element if certain restrictions are to be applied to the data sequence. Some examples of restrictions or deviations that could be applied are given below. If a “token” data type is applied, e.g. following restrictions could be considered: Should the application during correction or presentation take into account punctuation ? Should the application during correction or presentation take into account case sensitivity (upper case—lower case sensitivity ?) ? Should whitespace be taken into account. If a “double” data type is applied, one could question how far the data sequence may differ from the correction key without the answer being considered as being an error. Allowed deviations from the correction key can for example be determined using nominal intervals of deviation, proportional intervals of deviation, intervals based on significant numbers, etc.

Another principle that can be taken into account when considering a data sequence as an element, is that, if for example when the data sequence is a numerical value being the result of a calculation based on numerical elements in the question or answer, correction can be either directly on the numerical value, but can also take into account the way of calculation of the numerical value, i.e. how the student obtains such a numerical value. In other words, is the result based on a formula and does the formula need to be taken into account for correction.

Element building blocks typically may e.g. be obtained by splitting the data sequence representative for the question and the answer in a linear manner. Elements can contain a plurality of values. For example, multiple values of an element can be used if e.g. the teacher considers that alternative solutions also should be considered. Two examples of possible ways for adding alternative solutions to an element, which optionally can combined, are given below. The teacher can phrase alternative solutions when he constructs the correction key, i.e. for example when the question is formulated. In this way of adding alternative solutions, such alternatives are defined before the test is published.

The teacher can alternatively or in addition thereto also use the application for suggesting alternative solutions, e.g. based on the answers given during the test. In one embodiment, the application can determine for a group of people that have taken the test, determine the uniquely received answers. These are shown to the teacher, optionally with the number of times the answers are given as reply to the question in the test. The teacher can then, based thereon, decide whether or not for correction these answers should be considered as alternative values in the elements which are building blocks of the correction key answer. In this last way of adding alternative solutions, the application thus may be programmed for indicating the teacher the replies given and for allowing the teacher to select from the replies those values that need to be added as alternative solutions in the correction key. This technique allows to reward valuable alternative answers and thus results in a more fair correction method.

If multiple values are present in the element, each value of the element may be marked as required. Different marks for different values of the element may be required as, for example, alternative solutions may be valuable but may be considered to attrack only part of the marks. An example of the content of an element is shown in FIG. 6, being a visual representation of an element.

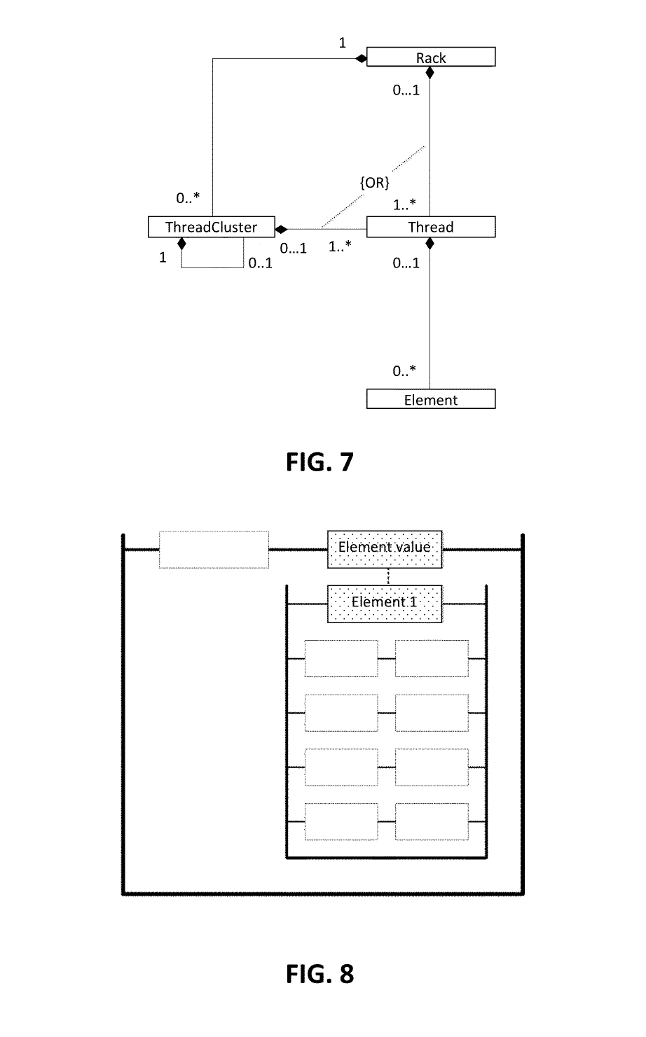

A second type of building block in the four-type building block example illustrated here, is a thread. According to the particular set of embodiments, a thread is a sequence of consecutive elements and/or racks who as an entity fulfill a specific role in the question. The type of thread is determined by on the one hand the type of relation with respect to its rack and on the other hand the type (ToCorrect) of its elements and/or racks. By way of illustration, the unified modeling language scheme of a thread is shown in FIG. 7. According to the model, a thread consists of elements. De building block thread can be directly linked to a rack or can belong to a cluster that is linked to a rack.

Based on the above given definition of a thread, a thread can be characterized by the type of elements being linked to the thread or by the way the thread is linked to its rack. A number of examples of types of threads is illustrated below, embodiments of the present invention not being limited thereto:

“Presentation”: is a type of a thread that contains only elements (or racks) that don't need to be corrected. The thread is then directly and uniquely connected to its rack.

“Fixed”: is a type of thread that contains at least 1 element (or rack) to be corrected. The thread is then directly connected to its rack and is also connected to a “fixed”-type threadcluster. The position of the thread in its rack is fixed.

“Free”: is a type of thread that contains at least 1 element (or rack) to be corrected. The thread is then directly connected to its rack and is also connected to a “interchangeable”-type threadcluster. Threads that belong to the same threadcluster are interchangeable under certain specified conditions.

“Idle”: is a type of thread that contains at least 1 element (or rack) to be corrected. The thread is initially not connected to a rack, but is connected to a threadcluster of “exchangeable”-type. An idle thread is hence not directly connected to its rack, but only indirectly through a threadcluster. An idle thread (a thread in an “exchangeable”-type threadcluster) can under circumstances take the position of a thread in an “interchangeable”-type threadcluster. It is also the case that a threadcluster of the “exchangeable”-type (child) always belongs to a specific threadcluster of the “interchangeable”-type (parent). As a result, an idle thread in an “exchangeable”-type threadcluster has to be a least structurally equivalent to one of the threads of its parent threadcluster.

For “idle” or “exchangeable” type anchors, at least one of the elements or racks belonging to the thread functions as anchor. A thread can have one or more anchors. The anchor(s) of threads may be used for determining the ordering or correcting process.

According to some embodiments of the present invention, a third building block that is used in the data structure is a rack. A rack can be defined as a collection of threads that constitute (formulate) the question (or subquestion). Besides threads, a rack may contain clusters, boundary conditions and deviation margin (tolerance) that allow the application to correct the question. Using racks provides an efficient manner for having—when the threads are linked to a rack—the question fully electronically phrased. This does not necessarily imply that the electronic question can also be corrected fully electronically. Correction may require the use of an additional building block, such as for example a cluster. Optional boundary conditions and deviations may furthermore be used for refining the correction, presentation and/or ordering process.

According to some embodiments of the present invention, another building block that may be used in the data structure is a cluster. A cluster is a collection of similar building blocks (elements, threads, racks) of a rack that need to be corrected. The type of collection of the building blocks may determine the relation between the building blocks in the collection (interchange), the relation between the building blocks belonging to equivalent collections (interchange, exchange) and/or the relation between building blocks belonging to different collections (interchange, fixed and boundary conditions) in the sorting, presentation and/or correcting process. The type and constitution of clusters is deterministic for the actions that can be performed by the application on the building blocks that form the electronic question. Clustering of building blocks may thus be considered as determining how the building blocks relate to each other. Clusters may determine the relations that can occur between the building blocks. By way of illustration, a number of cluster types is described below, embodiments of the present invention not being limited thereto:

“Fixed cluster type”: building blocks assigned to a “fixed” cluster are building blocks that have a fixed position relative to its ‘collecting’ building block. This implies that the position of elements and/or racks relative to their thread and of threads relative to their rack are fixed. In other words: the application must ensure that these building block cannot change their position with respect to their ‘collecting’ module.

“Interchangeable cluster type”: Building blocks assigned to an “interchangeable” cluster are building blocks that can change their position up to a certain extent. That is, they may only change places within their cluster. The application assures that those building blocks are interchangeable within their cluster.

“Exchangeable cluster type”: This type of cluster can never exist independently. It is always associated with a cluster of the “interchangeable”-type. Building blocks assigned to an “exchangeable” cluster can always take the position of a building block of the associated “interchangeable”-type cluster.

According to embodiments of the present invention, building blocks typically can only belong to one specific cluster which implies that clusters with the same building block bind (such as a collection of element clusters, or a collection of thread clusters, or a collection of rack clusters) and of the “interchangeable”-type are commutative in the sorting process. This means that the order in which multiple clusters with the same building block bind are being processed doesn't matter for the end result.

Another feature of embodiments of the present invention is that the data structure used can be built up so that a structure with more levels than the number of types of hierarchical building blocks described above is created. The latter can be obtained by considering, for a given type of hierarchical building block, an equally high or higher hierarchical type of building block as its elements. By way of illustration, the latter is explained for the four building blocks based system as described above. The data structure can be obtained by replacing for example an element in a rack by a rack, the rack being a collection of threads whereby the threads are a sequence of elements. Similar procedures and principles for sorting racks in a rack are applicable as for sorting elements in a rack. Such principles can be applied by considering the rack as a meta-element, whereby the meta-element is achieved by identifying the rack by one of the elements being present in the rack. In other words, the meta-element is obtained by appointing one element of the rack as identifier of the rack for indicating that the rack is part of the thread to which it is linked. The dependency between the meta-element and the identifier element is maintained throughout processing, i.e. changes to the identifier element in the rack are also immediately implemented in the meta-element. By way of illustration, an example of how a rack can act as an element of a thread is shown in FIG. 8.

As indicated above, according to embodiments of the present invention, a building block, e.g. a higher hierarchical building block, can contain information regarding the conditions answers need to fulfill or deviations that are allowed on answers. The boundary conditions formulate rules regarding the way the correction application should deal with threads. It may include different kinds of rules, some examples being given below:

One type of rules relates to rules regarding the correction method of anchors and other elements on a thread. Some examples thereof can correspond with “if the anchor element is wrong, correct the remaining elements to be corrected”, or “if the anchor element is right, check the remaining elements to be corrected prior to taking a decision”.

Another type of rules relates to rules regarding the treatment of multiple threads with the same anchor elements within a cluster. Yet another type of rules relates to rules regarding the treatment of multiple threads with the same anchor elements and belonging to different clusters. Examples of such rules can for example be:

“SUM rule”: threads having the same anchor element need to be combined. This implies that the contents of the elements on the corresponding threads are summed where possible. The rule typically may be implemented if threads are structurally equivalent.

“FIOC rule”: If threads with the same anchor elements occur several times, than only the thread of these threads that is found first is corrected. This implies that only the content of elements that need to be scored on the first thread found will be scored.

“MURA rule”: If threads with the same anchor elements occur multiple times, than do not correct any of these threads. This implies that for all the elements to be scored on these threads obtain a score 0.

“THRESHOLD rule”: if the marks obtained for a certain part of a question do not exceed a certain threshold score, the actual score assigned is considered 0. This implies that all threads are scored and that the thus obtained score is compared with a threshold score. Depending on this comparison, the actual assigned score is determined.

In order to apply rules for certain questions, the teacher introducing the question may be provided with the possibility for activating certain rules, for a given hierarchical building block, e.g. for a cluster or even for a set of clusters. For example in the four building block based embodiment described above, the application may be adapted for activating rules directly for certain building blocks, by activating the rules for each of the clusters. Alternatively or in addition thereto, the application may provide the teacher first with the possibility for defining an umbrella cluster and for activating rules for the umbrella cluster.

In some embodiments, deviations can be defined. The deviations can be defined at a given building block level, e.g. at rack level when considering the four building blocks based embodiment. If deviations are introduced at a given level, typically all building blocks being linked to the higher building block, e.g. all elements in the rack, will automatically take this property, unless otherwise indicated for the user.

The defined deviation may play a role in the sorting and correcting process. The deviation can determine the degree wherein the answers given by the students can differ from the answers of the correction key. The possibility for refining the correction can substantially be dependent on the criteria implemented and on how the criteria can be implemented. Some examples on how deviation can be applied are discussed below.

If for example an element has as a datatype “token”, the variability that is allowed may be determined by the deviation that is allowed during the sorting and/or correction process.

Deviations that may be considered then are:

Does one need to take into account punctuation during correction and/or sorting

Does one need to take into account case sensitivity during correction and/or sorting

Does one need to take into account white space during correction and/or sorting.

It is to be noticed that punctuation, case sensitivity and whitespace, typically do not or hardly allow content-dependent deviations. The user determines the deviations that can be determined, this is not implemented by the application. It is possible that, for example criteria can be implemented for taking into account spelling of words. In another example, variability may be allowed or refused based on distances between strings, e.g. using the Damerau-Levenshtein alrgorithm. The latter can for example be advantageous as typically it is seen that spelling errors occur below a string distance of 2.

If for example an element is of the data type “double”, one can allow variability by defining an interval wherein the answer may be for which the answer is considered correct. Such intervals can be nominal ranges or proportional ranges.

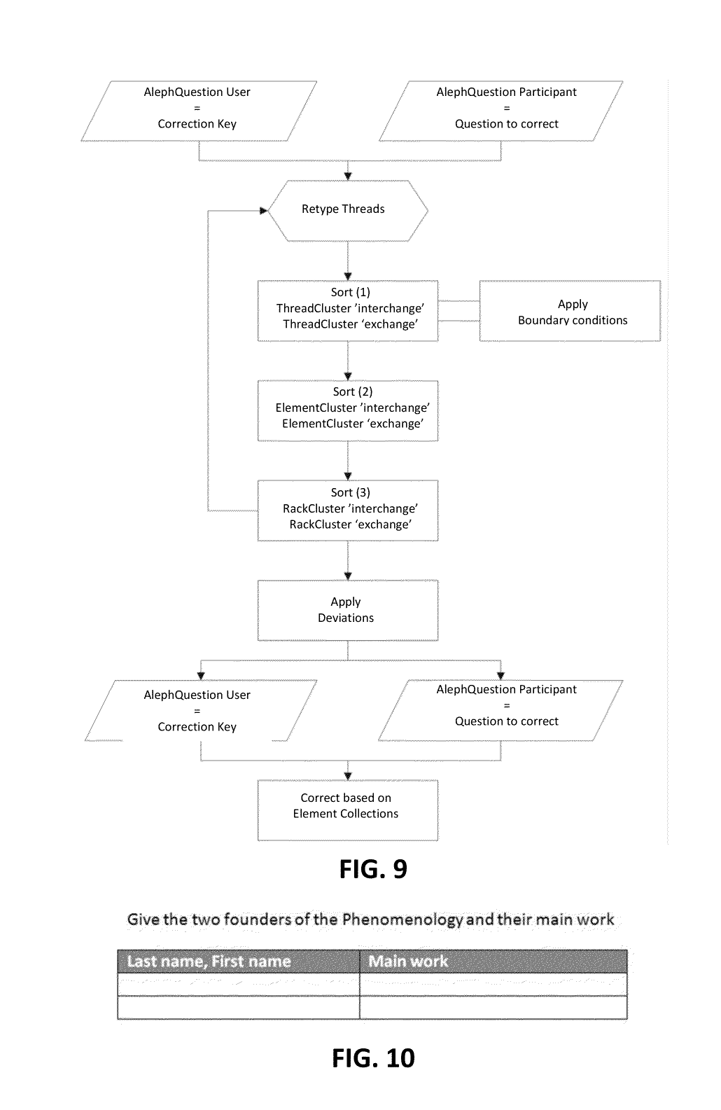

Another feature, as may be present in embodiments of the present invention as also indicated above, is the use of a sorting process. In one embodiment, such a sorting process may be performed as described below. Sorting may be performed from higher level to lower level building block, i.e. outside to inside—just like a Matryoshka. This implies for the four building blocks based embodiment that the sorting process starts from e.g. the rack directly related to the question. The sorting process within a building block may also be performed by certain rules that follow from the data model, as illustrated in FIG. 9 for the four building block based embodiments.

In one advantageous embodiment, sorting threads through thread clusters always has priority over the sorting of elements or racks through their respective clusters.

In one advantageous embodiment, after threads are sorted the applications sort the elements and/or racks based on their respective clusters. Whether the application starts with the element clusters or with the rackclusters may be irrelevant: the processing sequence may play no role, as elements and racks on threads have the same role.

The order in which thread clusters (or element clusters or rack clusters) of the ‘interchangeable’-type are processed may be considered irrelevant. This follows from the fact that a thread (or element or rack) belong to exactly 1 thread cluster (or element cluster or rack cluster). Despite this, the application must process the thread cluster (or element cluster or rack cluster) of the ‘exchangeable’-type after processing the thread cluster (or element cluster or rack cluster) of the ‘interchangeable’-type before starting to process the next thread cluster of the ‘interchangeable’-type (or element cluster or rack cluster).

As indicated above, in at least some of the embodiments of the present invention, the data structure building blocks referred to are described as racks, threads and elements. It thereby is important to note that the number of elements in different threads can be different, in other words, threads do not need to have an equal number of elements. Furthermore, threads can easily be inhomogeneous. For example, a thread may comprise one or more elements but also may comprise a rack as an element. It also is to be noticed that an element can contain more than one value, i.e. multiple element values may be present in the same element.

For sorting the elements, elements do not need to be ordered in horizontal or vertical arrays and furthermore, they do not need to be part of a group of neighbouring elements to allow accurate sorting.

Where in embodiments of the present invention reference is made to anchor elements or anchors, these anchors may typically be less restricted than e.g. unique keys in a relational datastructure. For example, anchors may and even sometimes must have a null value in the correction key.

In embodiments of the present invention, part of the threads may be non-unique. Typically, if one wishes to have uniqueness, this can only be guaranteed for these threads that have their anchor at the same position.

According to at least some embodiments of the present invention, the goal of electronic correction may be correcting an answer given by the student taking into account certain premises with respect to the behavior of the student and taking into account the knowledge one wants to test. Consequently, there can be variability in what the teacher considers correct. Variability may not only refer to the student's response, but also to the way the student replies, such as taking into account guessing behavior, misleading behavior, etc. In order to provide the possibility for the user to take this into account, uniqueness should not be implemented. The way of handling this variability can e.g. better be determined by boundary conditions or deviations, as described above.

By way of illustration—embodiments of the present invention not being limited thereto—some examples of how questions are implemented in the test and correction tools, are discussed below.

The authors further discuss hereafter the possibilities of test and correction applications. The various features and combinations of features will be described with reference to actual examination questions.

To enable comparison, the authors have defined an ‘Abstract Universe’. They also have defined a syntax (analogous to the one in mathematics and logic) and terminology which allows formulation of the descriptions in a short and unambiguous way.

Since the authors wish to compare the features between “question type based” applications as known from prior art and “model based” applications according to the present invention, the authors have also defined a syntax and terminology and an abstract universe allowing the comparison to be made. This terminology also allows unambiguous description of the claim and the description.

### Terminology and Syntax Used in the Current Example:

U: user (teacher)
QT: test and correction application based on “question types”
q_{U}=q_{Qt}: the question of the user and the question in the correction application are equivalent.
q_{U}≈q_{QT}: the question of the user and the question in the correction application show strong similarities.
q_{U}<q_{QT}: the question of the user provides less information than the question in the correction application.
q: a question
qₓ: a question of type x, where x stands for question type

qₓ_{ᵢ} where i ε {1, . . . , n}: an existing question type in QT

q_{y}_{ᵢ} where i ε {1, . . . , n}: a question type not-implemented in QT

q_{z}_{ᵢ} where i ε {1, . . . , n}: a question that looks similar to an existing question type q_{NU}: translation of q_{U} in Aleph-Q
+: sequence of questions (the questions may be presented in a random order, and may be shown simultaneously)
\vec{+}: sequence of questions (the questions have to be presented in the given order, and may not be shown simultaneously; the participant cannot return to a previous question).
T: the questions need to be presented as a whole (the questions form a single test)
├: “shows that”

### Assumptions of the Abstract Universe

1. The user (teacher) lives in a world without electronic correction applications (world 1) and has no visibility on other worlds. He phrases the question.
2. The operator lives in a world with electronic correction applications (world 2) and has no visibility on other worlds. He receives a question, and converts this, if possible, in a correction application. The operator implements the questions in the best possible way in the given correction application.
3. In the world of electronic correction applications abstraction is made of the following matters:
a) The way of how the implemented question is presented to the user or participant is not taken into account.
b) Abstraction is made of the correction process. This implies that possible shortcomings in the correction process of existing applications are disregarded. It is therefore assumed that whatever may in principle be technically implementable in terms of addition of alternative answers, after-correction, assigning negative scores, partial points, reporting, etc, are equivalent.
c) The question needs to be solved without having to adapt the correction algorithm of the given correction application.
4. Under known correction applications (QT) is understood electronic correction applications operating based on question types. This implies that choosing a question type is identical to formulating a question (q=q_{QTx}_{ᵢ}). These electronic correction applications comprise a finite number of question types (q_{QTx}_{ᵢ} where i ε {1, . . . , 25}).
5. Aleph-Q is a correction application that is not based on question types. The application translates the input question to the Aleph-Q model, such that it becomes correctable. For Aleph-Q an additional restrictive condition is applied: the question of the user has to be implemented already in the existing correction application currently available and operational at the University of Antwerp. This correction application is only a limited implementation of the Aleph-Q model, since there is currently a specific restriction imposed on one of the building blocks.
The abstract universe plays in various aspects to the detriment of Aleph-Q:
1) because correction method is disregarded. The model allows default a correction method that is significantly more refined and differentiated than is currently possible in test- and correction applications based on question types. This is possible because the model allows quotes, constraints and deviations in the smallest building block of the model.
2) due to the restriction of actual demonstrable within a working application based on Aleph-Q. The current working application imposes a restriction on the largest building block of the model. This restriction was made for pragmatic reasons. The restriction is not necessary nor desirable if the problem of automatic correction of ‘T accounts’ is to be solved.
3) In the following descriptions, the authors will make additional assumptions to the benefit of test- and correction applications based on question types. For example, the question type ‘Calculated numerical value’ will be expanded to ‘Calculated numerical matrix’. This assumption is possible because the authors assume that if a single numerical value can be corrected, also multiple values can be corrected.

### FIRST EXAMPLE

The question of the user is a question within the domain of Philosophy.

The question illustrates the problem of test- and correction applications (based on question types) where the electronic question contains more information than originally desired (option 2) and where the original question falls apart in multiple questions (option 3). This solution is necessary in these applications in order to allow automatic correction. Since the question can seamlessly be entered in a test- and correction application based on the Aleph-Q model, and can be corrected as desired in this application, this also shows the advantage of a model-based test- and correction application.

### In World 1:

q_{U}: the question is presented on paper as shown in FIG. 10.

question: “Name the two founders of the Phenomenology and their main work”.

The correct answer to this question is:

Husserl, Edmond—Logische Untersuchungen

Heidegger, Martin—Sein and Zeit

### In World 2 (Correction Application Based on Question Types):

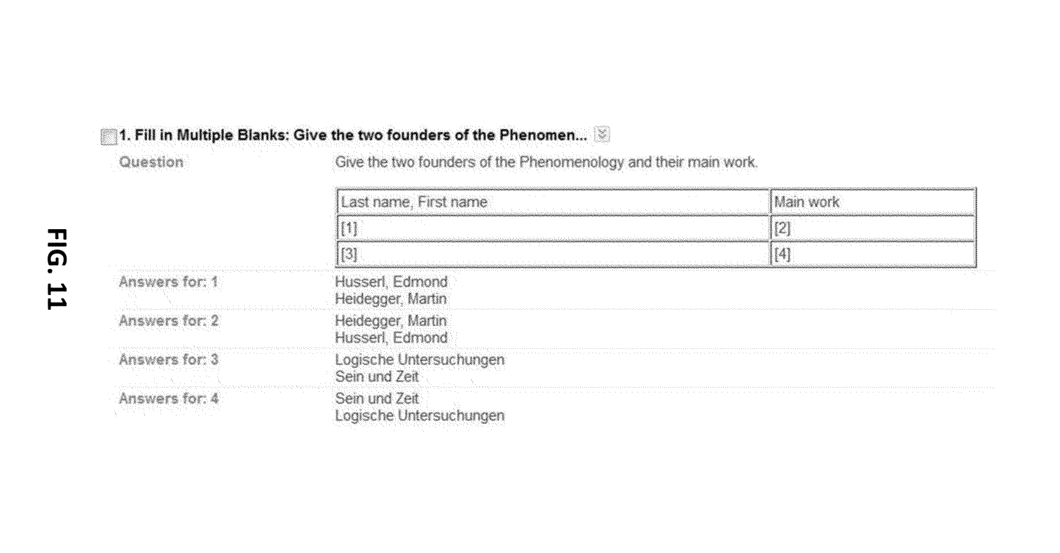

Apparently, the question received should be entered as a “Multiple blanks” question type (also known as “fill in the blanks” question type). This would yield a representation as shown in FIG. 11, whereby [1], [2], [3] and [4] are input fields from a participants perspective. The problem of this solution shows itself already in the “Answers for”. Since the operator does not know in which of the fields the participant will fill out “Husserl, Edmond” or “Heidegger, Martin”, he is forced to provide every opportunity.

This has the result that incorrect combinations, such as the following, will also be evaluated as correct:

Husserl, Edmond—Sein and Zeit

Heidegger, Martin—Logische Untersuchungen

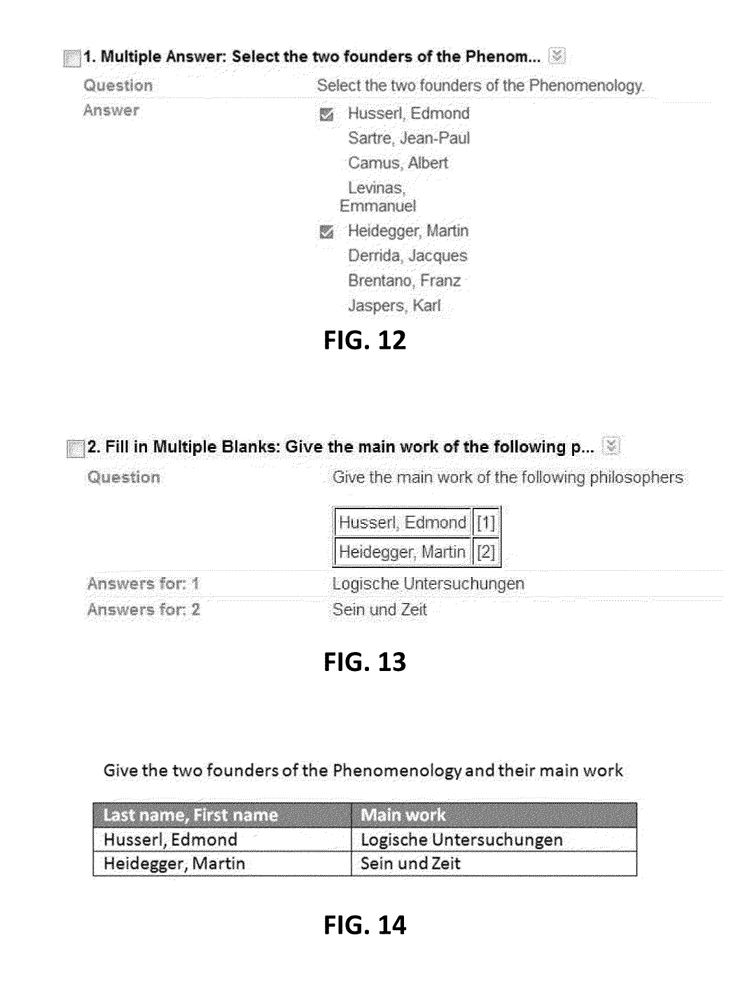

This apparent solution of the problem is incorrect. However, this question can certainly be formulated as a combination of ‘Multiple Response Options’ and presented as a ‘Multiple Blanks’ question type, as shown in FIG. 12. The ‘Multiple Response Options’ presents a list of names. If the participant checks the right names, he receives a score.

The “Multiple blanks ” is then formulated as shown in FIG. 13. To prevent that the participant uses the data provided by question 2 to correct his answer to question 1, the operator needs to indicate that the participant may not return to the previous question.

In this solution of the problem, two aspects come to surface:

1) In both the ‘Multiple Response Options’ as well as in the ‘Multiple Blanks’ question type the operator needs to provide more information than was given in the original question. In the ‘Multiple Response Options’ the correct solution (“Husserl, Edmond” and “Heidegger, Martin”) are stated. Even though the user has to select the right solution, the fact that the correct names are listed, works to the advantage of the user. In the “Multiple Blanks” approach, this problem is less present.

2) It is also the case that the original request is split into two questions. These questions need to be answered strictly sequentially by the user, whereby the user is no longer given the opportunity of returning to a previous question.

Summarizing, the solution can be described as follows:

### In QT:

q_{U}<q_{QTx}_{₁}\vec{+}q_{QTx}_{₂}

whereby:

x₁: Multiple Response Options

x₂: Multiple Blanks

and whereby:
q_{U}<q_{QTx}_{₁} because ‘Heidegger, Martin’ and ‘Husserl, Edmond’ are presented in the optional answers,
q_{U}<q_{QTx}_{₂} because ‘Heidegger, Martin’ and ‘Husserl, Edmond’ are present in the question formulation.

### In Correction Application—Model Aleph-Q:

The received request is implemented as shown in FIG. 14. It will not be explained in detail here of how and why. The solution in this correction application shows many similarities with the ‘Multiple blanks’ with the important difference that the answer is correctable in a manner as originally intended.

Summarizing, this solution can be described as follows:

### In Aleph-Q:

q_{U}=q_{z}_{₂}=q_{NU}

whereby:

z₂≈x₂: Multiple Blanks exercise

### SECOND EXAMPLE

The question of the user (teacher) is a question within the domain of Chemistry. This example is a standard exam question in the first Bachelor of Biomedical Science and first Bachelor of Veterinary Medicine. The question is being developed on the basis of practical experience gained by the authors for this case. This question demonstrates the difficulties that arise in a test- and correction application that is based on question types, because solutions are possible, but none of them is satisfactory.

### In World 1:

q_{U}: the question is presented in a written exam, as follows:

Provide the reaction-equation of the following reaction in its balanced and essential form: the reaction of oxalic acid (H₂C₂O₄) with sodium dichromate to carbon dioxide and trivalent chromium. Make additions to these substances, if required.

The correct answer to this question is:

H₂C₂O₄+Cr₂O₇²⁻+8H⁺→6CO₂+2Cr³⁺+7H₂O

### In World 2 (Correction Application Based on Question Types):

The operator quickly comes to the conclusion that different solutions are possible. Each solution has its pros and cons.

A first solution is to implement the question as a “Fill in the Blanks.” This has the advantage that not more information is presented in the electronic question than originally desired. The disadvantage of this solution is that automatic correction is practically given up. The only way to correct the answer is then by means of after-correction. The after-correction process involves the following steps:

1. Collect unique answers based on the submitted answers

2. Rate these unique answers.

3. Apply the rated unique answers to all the submitted answers.

Experience learns the operator that he gains (of time) he obtains from this solution, are too small to apply after-correction. After-correction is only meaningful if the collection of unique responses reduces the number of given answers by at least 40%. In the example given, the reduction is at most 10% to 15%. The latter implies that it doesn't help the user (teacher) to take the test electronically, instead of via paper.

A second solution for this problem is to use a “Multiple Choice” kind of question, where the distractors (i.e. alternative but wrong answers) are very well chosen. The disadvantage of this solution is that the correct answer needs to be shown between the distractors. In short, in this solution more information is given than originally desired.

The 3rd solution to this problem is to use two ‘Multiple Response Options’ kind of questions. The first question would involve the ‘reacting agents’, the second question would involve the ‘products’. Although this solution has the same drawback as the previous solution, in particular that the reacting agents and products need to be displayed between a sufficient number of well chosen distractors, this solution is better. The operator knows from experience that ‘Multiple Response Options’ kind of questions increases the difficulty level, because the participant needs to check one or several answer options to achieve the correct result, whereas for a ‘Multiple Choice’ kind of question only option leads to a correct answer.

Given the “Abstract Universe” the first solution is preferable above the third, and the third solution above the second. Fact is that only the first solution does not completely change the question formulation. The original question formulation has the objective that the participant can and has to construct the reaction-equation himself. The second and third solution modify this objective into recognizing the correct reaction equation.

The above can be summarized as follows:

### In QT:

q_{U}=q_{QTx}_{₁}

whereby:

x₁: Multiple Blanks

### Correction Application—Model Aleph-Q:

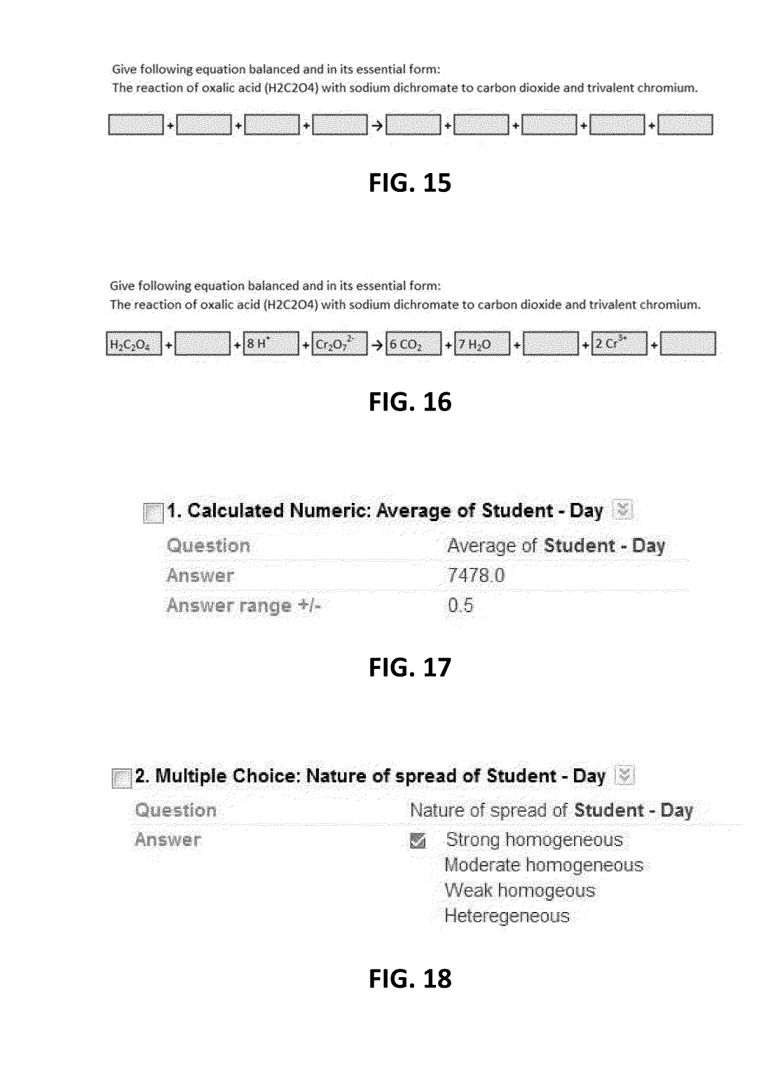

In the Aleph-Q model, the phrased question is implemented as shown in FIG. 15. We do not go into the details here of how and why this is implemented. The solution in this correction application shows many similarities with the ‘Multiple Blanks”, with the important difference that the answer is correctable in a manner as originally intended, and that (manual) after-correction can be omitted. It doesn't matter in which of the blank fields of the “reacting agents” resp. “products” group the participant writes the formulas of the reacting agents resp. products, the correction process always works correctly and fully automatic. FIG. 16 shows an example of FIG. 15 filled out by a participant.

The above can be summarized as follows:

### In Aleph-Q:

q_{U}=q_{z}_{₁}=q_{NU}

whereby:

z₁≈x₁: Multiple Blanks

### THIRD EXAMPLE

The question of the user (teacher) is situated in the field of Statistics. The question illustrates the problem of test- and correction applications (based on question types), whereby the electronic questioning is equivalent to the original question (option 1), but whereby the original question falls apart in multiple questions (option 3). This solution is necessary in this case in order to allow automatic correction. As the question can seamlessly be entered into a test- and correction application based on the Aleph-Q model, and in this application can be automatically corrected (as intended), this example also shows the advantage of a model-based test- and correction application.

### In World 1:

qᵤ: the question is presented on paper as follows:

question: “Calculate the requested values (shown in table 1) based on the given data (shown in table 2”

### In World 2 (Correction Application Based on Question Types):

The operator correctly notes that the received question can be readily converted into the correction application.

The ‘Mode’, ‘Average’, ‘Median’, ‘Standard Deviation’, ‘Variation coefficient’, ‘Kurtosis’ and ‘Skewness’ can be entered via the question-type ‘Calculated numerical value’ and are therefore formulated as shown in FIG. 17 for each requested item (note: the answer is also shown in FIG. 17).

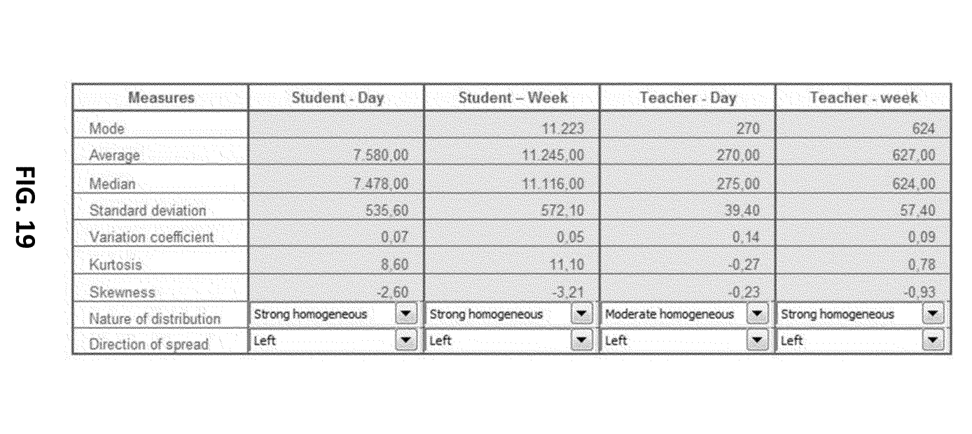

The ‘Nature of distribution’ and ‘Direction of spread’ can be presented in a ‘Multiple Choice’ question, and is thus formulated as shown in FIG. 18 for each item requested:

The proposed problem is thereby correctly solved.

Summarizing, the above solution can be described as follows:

### In QT:

TABLE 1

| Measures | Student- | Student- | Teacher- | Teacher- |
|---|---|---|---|---|
| Mode | | | | |
| Average | | | | |
| Median | | | | |
| Standard deviation | | | | |
| Variation | | | | |
| Kurtosis | | | | |
| Skewness | | | | |
| Nature of | | | | |
| distribution (1) | | | | |
| Direction of | | | | |
| spread (2) | | | | |

(1) Nature of distribution: Strong homogeneous, Moderate homogeneous, Weak homogeneous, Heteregeneous
(2) Direction of spread: Left, Normal, Right

TABLE 2

| Observations | Student- | Student- | Teacher- | Teacher- |
|---|---|---|---|---|
| 1 | 5576 | | 192 | |
| 2 | 7388 | 10347 | 290 | 565 |
| 3 | 7631 | 11324 | 328 | 683 |
| 4 | 7597 | 11352 | 334 | 691 |
| 5 | 7943 | 11385 | 332 | 696 |
| 6 | 7476 | 11377 | 291 | 689 |
| 7 | 7563 | 11347 | 324 | 667 |
| 8 | 7962 | 11511 | 310 | 675 |
| 9 | 7684 | 11125 | 243 | 526 |
| 10 | 7431 | 11223 | 256 | 624 |
| 11 | 7188 | 11190 | 261 | 607 |
| 12 | 7694 | 11223 | 262 | 632 |
| 13 | 7421 | 11201 | 270 | 616 |
| 14 | 8101 | 11265 | 272 | 630 |
| 15 | 7672 | 11449 | 270 | 634 |
| 16 | 7814 | 11475 | 247 | 624 |
| 17 | 7542 | 11225 | 258 | 613 |

### First Translation of the Question:

q_{U}=T(n×q_{QTx}_{₁}+m×q_{QTx}_{₂})

whereby:

x₁: calculated numerical value (n=28)

x₂: multiple choice (m=8)

and second translation of the question:

q_{U}=T(q_{QTx}_{₁}+m×q_{QTx}_{₂})

whereby:

x₁: calculated numerical value matrix

x₂: multiple choice matrix (m=8)

### Correction Application—Model Alpha-Q:

The received request is implemented as shown in FIG. 19. We do not go into the details here of how and why this is implemented. The possible options in ‘Nature of distribution’ and ‘direction of spread’ are displayed in drop-down lists (also known as “combo boxes”).

### In Aleph-Q:

q_{U}=q_{n×z}_{₁}_{,m×z}_{₂}=q_{NU}

whereby:

z₁≈x₁: calculated numerical value

z₂≈x₂: multiple choice

### FOURTH EXAMPLE

The question of the user (teacher) is situated in the field of Accountancy.

q_{U}: the question is presented on paper as follows:

### Question:

VAT is not applicable in this question.

On Mar. 1, 2010 Herman, the son of Mr. Miller, starts a private company (Greenleaf), a tree nursery. Thereto, he brings in a site worth 250.000,00 in (Deed/2358—Jan. 3, 2010). Herman decides to instantly activate the legal costs associated with the start-up, amounting to 2.500,00 (AF/01—Mar. 10, 2010). The notary is paid by bank transfer (RU/1—Mar. 13, 2010).

On May 1, 2010 Herman takes in the name of Greenleaf a loan with a duration of 48 months at KBB bank for 50.000,00 with the terrain as security. The amount is placed on the current account (RU/2—May 1, 2010). The loaned amount is payed back at the end of the duration by a single payment. The KBB Bank charges interest at 6% annually in arrears, the first time on Apr. 30, 2011 (RU/89—Apr. 30, 2011). The registration fees charged for this loan is 4.300,00 (DIV/01—May 1, 2010)+(RU/3—May 10, 2010). Only at the end of the bookyear Herman realizes that the cost of the loan can be spread over time, and he takes the necessary actions for achieving this in the most optimal way (DIV/18—Dec. 31, 2010). He wears the full result for the bookyear to the next financial bookyear.

### Requested:

Journalize for Greenleaf the transaction(s) on Dec. 31, 2010.

(Four journal entries are provided in which the participant can write).

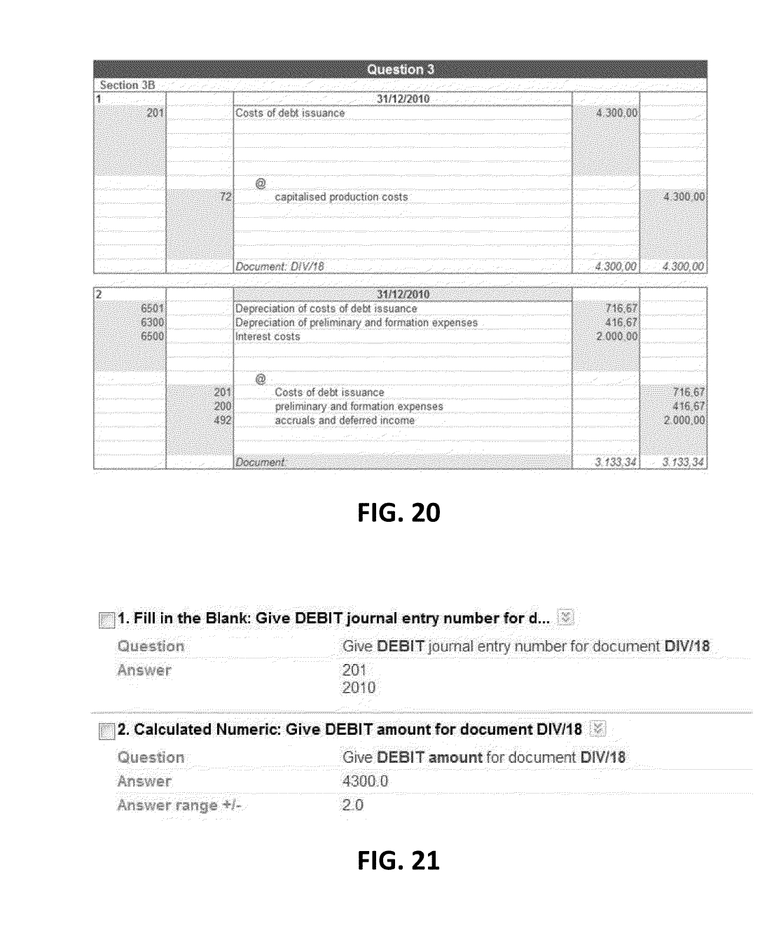

The correct answer to this question is shown in FIG. 20,

whereby:

Journal No. 201 in Journal post 1 may also be 2010

Journal No. 201 in Journal post 2 may also be 2019

Journal No. 200 in Journal post 2 may also be 2000

the entries in Journal post 1 effectively need to occur in Journal post 1.

the entries in Journal post 2 may be spread over journal posts 2, 3 and 4

### In World 2 (Correction Application Based on Question Types):

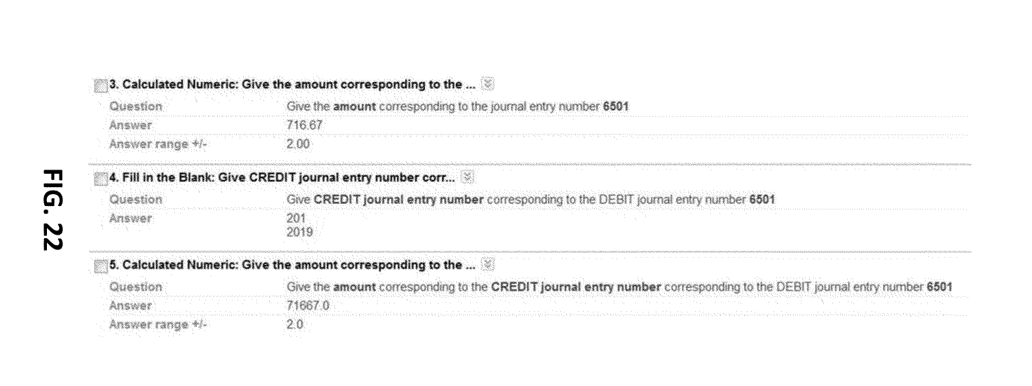

The operator correctly assumes that a possible solution consists in regarding the entries as a combination of “Fill in the Blank” and “Calculated numerical value”. This solution indeed works for the first Journal post. The solution may be entered as shown in FIG. 21.

The operator does the same for the CREDIT side of the first journal post. The executor attempts to solve the subsequent entries in the same way, but notes that due to lack of evidence, he cannot know what the participant will do, or rather what the participant knows. The operator may consider to partly reveal the journal numbers, coming to the solution shown in FIG. 22.

While the operator further implements this solution, he starts to realize that this solution is not satisfactory, for the following reasons:

1) He assumed that debit and credit entries are a one-to-one relationship, but in essence they are n-to-m relationships. This implies that this solution is only one solution for this specific case.

2) This solution completely modifies the questioning. Contrary to the solution where the correct answer was hidden between distractors, now the full structure of the response is released, while leaving some parts blank, which the participant is asked to fill out. An object of the original question is exactly to verify if the participant can build the structure himself

The operator decides that the best solution is to use the question-type ‘Essay’. But this implies that the user (teacher) needs to check and correct all submitted answers himself. In short, the operator recognizes that electronic correction for this question is not possible without completely rephrasing the question. In other words: it is desirable that a new question-type is implemented which allows that this kind of question can be electronically corrected.

Summarizing, this can be described as follows:

### In QT:

q_{U}=q_{y}_{₁}

In other words, the question does not fit into an existing question-type that allows automatic correction, and the producer has to implement a new question-type.

### In Correction Application Based on Aleph-Q Model:

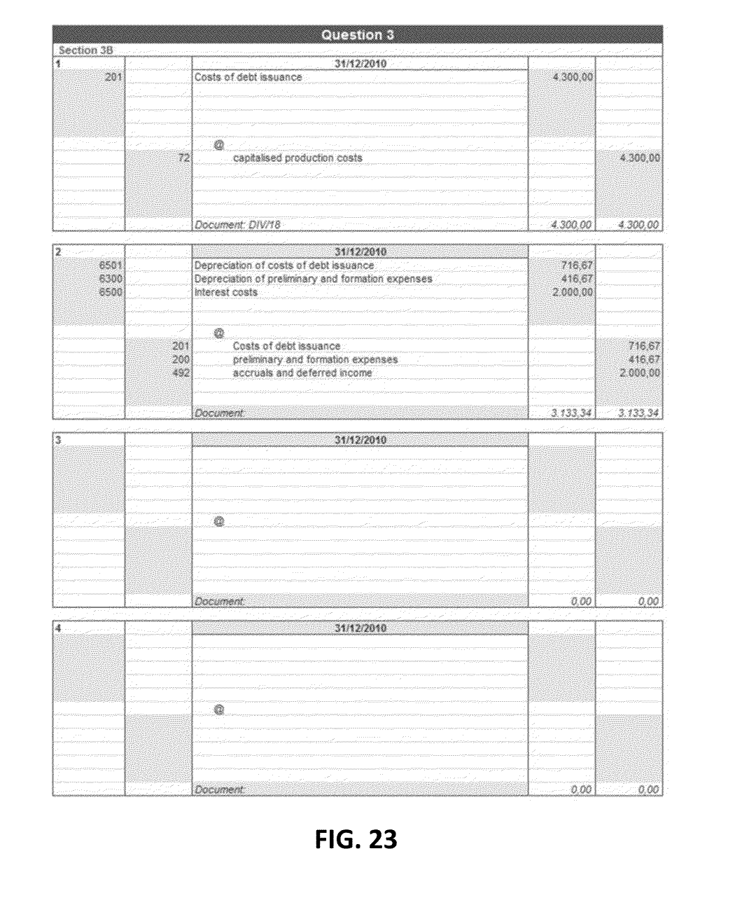

The question received is (literally) implemented as shown in FIG. 23. We currently do not go into the details of how and why this occurs. The received answer is hereby also fully automatically corrected.

whereby:

the element with Journal No. 201 in Journal post 1 has as alternative value 2010

the element with Journal No. 201 in Journal post 2 has as alternative value 2019

the element with Journal No. 200 in Journal post 2 has as alternative value 2000

the entries in Journal post 1 effectively need to occur in Journal post 1.

the entries in Journal post 2 may be spread over journal posts 2, 3 and 4

### In Aleph-Q:

q_{U}=q_{y}_{₁}=q_{NU}

In other words, the question is not known in Aleph-Q as question-type, but is nevertheless implemented in Aleph-Q by the operator.

1-16. (canceled)

17. A computer-implemented method for testing in an electronic learning environment, the computer-implemented method comprising:
receiving a data-input representative for a question/answer combination having an inherent question type, and,
for processing the data input representative for a question/answer combination, identifying for the data-input, a set of data building blocks representative for the question/answer combination, the data building blocks being hierarchically structured according to a predetermined data structure irrespective of the inherent question type of the question/answer combination.

18. A computer-implemented method according to claim 17, wherein the method furthermore comprises sorting the hierarchically structured data building blocks for processing them, wherein the sorting is performed according to a predetermined sorting algorithm, the predetermined sorting algorithm being irrespective or independent of the inherent question type of the question/answer combination.

19. A computer-implemented method according to claim 18, the method comprising using at least a type of higher level building blocks and a type of lower level building blocks whereby a plurality of lower level building blocks can be linked to one higher level building block, wherein the sorting comprises first sorting higher level building blocks and then sorting lower level building blocks.

20. A computer-implemented method according to claim 17, wherein at least two types of hierarchically structured building blocks are present.

21. A computer-implemented method according to claim 17, wherein four types of hierarchically structured building blocks are present, including:
a first type of building block (element) which represents a smallest structural content unit of a question/answer combination,
a second type of building block (thread) which is a sequence of consecutive first type of building blocks and/or third types of building blocks,
a third type of building block (rack) which is a collection of second type of building blocks and constitutes the question, and
a fourth type of building block (cluster) being a collection of similar first, second and/or third type of building blocks.

22. A computer-implemented method according to claim 18, wherein four types of hierarchically structured building blocks are present, including:
a first type of building block (element) which represents a smallest structural content unit of a question/answer combination,
a second type of building block (thread) which is a sequence of consecutive first type of building blocks and/or third types of building blocks,
a third type of building block (rack) which is a collection of second type of building blocks and constitutes the question, and
a fourth type of building block (cluster) being a collection of similar first, second and/or third type of building blocks.

23. A computer-implemented method according to claim 22, wherein sorting comprises:
starting from the third type of building block constituting the question,
first sorting threads through thread clusters,
then sorting elements or racks through their clusters.

24. A computer-implemented method according to claim 17, the method also comprising scoring a question/answer combination obtained from a student by comparing the building blocks with building blocks of an expert question/answer combination.

25. A computer-implemented method according to claim 17, wherein receiving a data-input representative for a question/answer combination comprises receiving a data-input representative for a nested question/answer combination, the nested question/answer combination combining a plurality of different inherent question types.

26. A computer-implemented method according to claim 17, wherein the method furthermore comprises receiving an adapted expert question/answer combination based on received question/answer combinations from students as reply to an original question/answer combination.

27. A computer-implemented method according to claim 17, wherein a higher type building block comprises boundary conditions or allowed deviations for the question/answer combination of the student, with respect to an expert question/answer combination.

28. A system for testing in an electronic learning environment, the system comprising:
an input port configured for receiving a data-input representative for a question/answer combination having an inherent question type, and
a processor programmed for identifying for the data-input, a set of data building blocks representative for the question/answer combination, the data building blocks being hierarchically structured according to a predetermined data structure irrespective of the inherent question type of the question/answer combination.

29. A system according to claim 28, the system furthermore being configured for performing a method for testing, the method comprising:
receiving a data-input representative for a question/answer combination, the question/answer combination having an inherent question type, and,
for processing the data input representative for a question/answer combination, identifying for the data-input, a set of data building blocks representative for the question/answer combination, the data building blocks being hierarchically structured according to a predetermined data structure irrespective of the inherent question type of the question/answer combination.

30. A system according to claim 28, the system being implemented as a computer application comprising a teacher application component and a student application component.

31. A computer program product for, if implemented on a processing unit, performing a method for testing in an electronic learning environment, the method comprising:
receiving a data-input representative for a question/answer combination, the question/answer combination having an inherent question type, and,
for processing the data input representative for a question/answer combination, identifying for the data-input, a set of data building blocks representative for the question/answer combination, the data building blocks being hierarchically structured according to a predetermined data structure irrespective of the inherent question type of the question/answer combination.

32. A data carrier storing a computer program product according to claim 31.

33. Transmission of a computer program product according to claim 31, over a wide or local area network.
